(19) United States
(12) Patent Application Publication
(10) Pub. No.: US 2019/0124253 A1
(43) Pub. Date: Apr. 25, 2019

(54) CAMERA APPARATUS FOR VEHICLE AND CONTROL METHOD THEREOF

(71) Applicant: Hyundai Mobis Co., Ltd., Seoul (KR)

(72) Inventors: Hyun Seok LEE, Yongin-si (KR); Jong Gun KIM, Yongin-si (KR); Soo Min KIM, Yongin-si (KR); Ki Beom KO, Yongin-si (KR); Kyung Yong PARK, Yongin-si (KR)

(21) Appl. No.: 16/168,139

(22) Filed: Oct. 23, 2018

(30) Foreign Application Priority Data
Oct. 24, 2017 (KR) 10-2017-0138258

(51) Int. Cl. H04N 5/232; B60R 1/00; H04N 5/268; H04N 5/247; H04W 4/48

(52) U.S. Cl. CPC H04N 5/23206; B60R 1/00; H04W 4/48; H04N 5/247; H04N 5/268

(57) ABSTRACT

A camera apparatus for a vehicle may include: an imaging module to take an image of an area around the vehicle; an image output unit to output the image taken by the imaging module; a communication unit to provide an interface for connecting to an in-vehicle communication network; and a control unit to operate the image output unit to output the image, when a designated signal according to an operation of a vehicle control unit is inputted from the communication unit.

### CROSS-REFERENCES TO RELATED APPLICATIONS

This application claims priority from and the benefit of Korean Patent Application No. 10-2017-0138258, filed on Oct. 24, 2017, which is hereby incorporated by reference for all purposes as if set forth herein.

### BACKGROUND

### Field

Exemplary embodiments relates to a camera apparatus for a vehicle and a control method thereof, and more particularly, to a camera apparatus for a vehicle, which is connected to an in-vehicle communication network, receives a signal according to an operation of a vehicle control unit, and outputs an image taken by a camera module when a designated signal is inputted, thereby providing a blind spot image, and a control method thereof.

### Discussion of the Background

In general, the view of a driver in a vehicle mostly faces forward. For the left/right and rear sides of the vehicle, however, the view of the driver is considerably covered and limited by the vehicle body.

In order to solve such a problem, a view support unit such as a side mirror is installed and used in a vehicle. Recently, a variety of techniques including a camera unit which takes an image of the outside of a vehicle and provides the image to a driver have been applied to a vehicle.

Recently, the AVM (Around View Monitoring) system has also been applied, which includes a plurality of cameras installed around a vehicle and provides a 360-degree image. The AVM system combines images around the vehicle, taken through a plurality of cameras which film areas around the vehicle, and provides a top view image (i.e. AVM image) through which the driver feels as if the driver saw the vehicle from the sky. Therefore, the driver can check an obstacle around the vehicle on the screen.

Furthermore, the BVM (Blind-spot View Monitoring) system shows a blind spot on the screen according to a driver's selection during driving.

The related art of the present invention is disclosed in Korean Patent Publication No. 2017-0043104 published on Apr. 20, 2017 and entitled “AVM system and method for synthesizing image with blind spot”.

The conventional systems additionally include a separate system, and a separate control unit receives an image of a camera and provides a service.

Therefore, an additional cost is required to construct the separate system. Furthermore, when the cameras are always turned on to provide an image, the control unit of the system switches the cameras according to an operation mode, and selectively outputs the image. Thus, the power consumption is inevitably increased.

The above information disclosed in this Background section is only for enhancement of understanding of the background of the invention and, therefore, it may contain information that does not constitute prior art.

### SUMMARY

Exemplary embodiments of the present invention are directed to a camera apparatus for a vehicle, which is connected to an in-vehicle communication network, receives a signal according to an operation of a vehicle control unit, and outputs an image taken by a camera module when a designated signal is inputted, thereby providing a blind spot image, and a control method thereof.

In one embodiment, a camera apparatus for a vehicle may include: an imaging module configured to take an image of an area around the vehicle; an image output unit configured to output the image taken by the imaging module; a communication unit configuration to provide an interface for connecting to an in-vehicle communication network; and a control unit configured to operate the image output unit to output the image, when a designated signal according to an operation of a vehicle control unit is inputted from the communication unit.

The in-vehicle communication network may include a CAN (Controller Area Network).

The designated signal may include one or more of a gear position-reverse (R) signal, a direction change signal, and a camera select signal.

In another embodiment, a control method of a camera apparatus for a vehicle may include: connecting to, by a control unit, an in-vehicle communication network through a communication unit, and receiving a signal according to an operation of a vehicle control unit; comparing, by the control unit, the received signal, and determining whether the received signal is a designated signal; and operating, by the control unit, an image output unit to output an image, when it is determined that the designated signal was received.

The control method may further include suspending, by the control unit, the operation of the image output unit or maintaining the suspended state, when it is determined that the designated signal was not received.

The in-vehicle communication network may include a CAN.

The designated signal may include one or more of a gear position-R signal, a direction change signal, and a camera select signal.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a camera apparatus for a vehicle in accordance with an embodiment of the present invention.

FIG. 2 illustrates a BVM system using the camera apparatus for a vehicle in accordance with the embodiment of the present invention.

FIG. 3 is a flowchart illustrating a control method of a camera apparatus for a vehicle in accordance with an embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Hereafter, a camera apparatus for a vehicle and a control method thereof in accordance with an embodiment of the present invention will be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

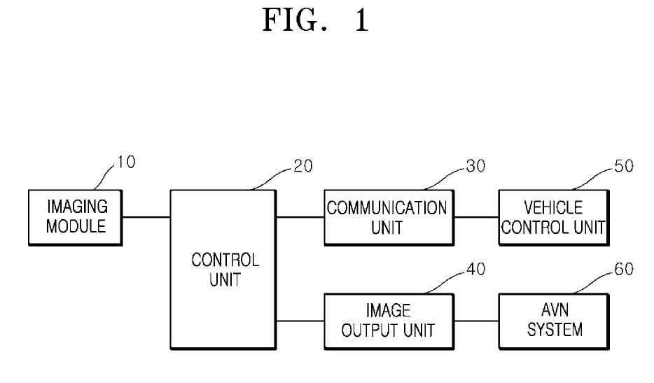

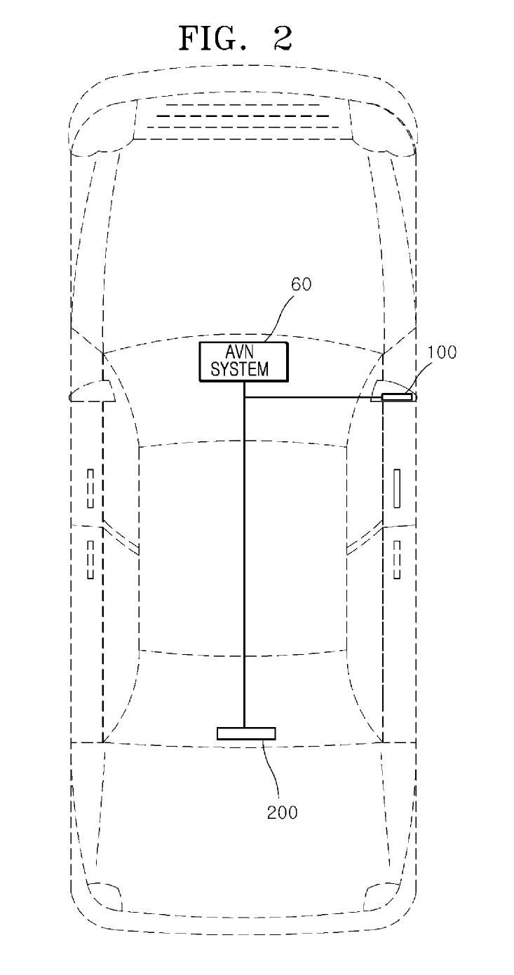

FIG. 1 is a block diagram illustrating a camera apparatus for a vehicle in accordance with an embodiment of the present invention, and FIG. 2 illustrates a BVM system using the camera apparatus for a vehicle in accordance with the embodiment of the present invention.

As illustrated in FIGS. 1 and 2, the camera apparatus in accordance with the embodiment of the present invention may include an imaging module 10, an image output unit 40, a communication unit 30 and a control unit 20.

The imaging module 10 may include an image sensor to take an image of the area around the vehicle.

The image output unit 40 may output the image taken by the imaging module 10 to the outside.

At this time, when an operation signal is inputted from the control unit 20, the image output unit 40 may be operated to provide an image to an external AVN (Audio Video Navigation) system 60.

The communication unit 30 may provide an interface for connecting to an in-vehicle communication network.

The in-vehicle communication network may include a CAN (Controller Area Network) which is connected to a vehicle control unit 50, and receive an operation state of the vehicle control unit 50 through CAN communication.

When a designated signal is inputted from the communication unit 30 according to the operation of the vehicle control unit 50, the control unit 20 may operate the image output unit 40 to output an image, such that a driver can see the image through the AVN system 60.

The designated signal may include one or more of a gear position-R signal, a direction change signal, and a camera select signal.

For example, as illustrated in FIG. 2, a first camera apparatus 100 may be installed at the right of the vehicle, a second camera apparatus 200 may be installed at the rear of the vehicle, and the first and second camera apparatuses may be connected to the AVN system 60.

At this time, the direction change signal may be set to the designated signal for the first camera apparatus 100, and the gear position-R signal may set to the designated signal for the second camera apparatus 200. Furthermore, the camera select signal may be set to the designated signal capable of selecting one or more of the first and second camera apparatuses 100 and 200.

Therefore, when the driver shifts a gearshift lever to position R, the vehicle control unit 50 may output the gear position-R signal through CAN communication in order to control the gearshift, and the control units 20 of the first and second camera apparatuses 100 and 200 may receive the gear position-R signal from the CAN communication through the communication units 30, and determine whether the designated signal has been received. At this time, since the gear position-R signal is the designated signal set in the second camera apparatus 200, the image output unit 40 of the second camera apparatus 200 may be operated to output an image to the AVN system 60.

When the driver operates a direction change switch, the vehicle control unit 50 may output the direction change signal through the CAN. Then, since the CAN signal received from the control unit 20 of the first camera apparatus 100 corresponds to the designated signal set in the first camera apparatus 100, the image output unit 40 of the first camera apparatus 100 may be operated to output an image to the AVN system 60.

When one or more of the first and second camera apparatuses 100 and 200 is selected through the camera select signal, the control unit 20 may recognize the camera select signal as the designated signal, and operate the image output unit 40 to output an image to the AVN system 60.

In accordance with the embodiment of the present invention, the camera apparatus for a vehicle can be connected to the in-vehicle communication network, receive a signal according to the operation of the vehicle control unit, and output an image taken by the camera module when the designated signal is inputted, thereby providing a blind spot image. Therefore, a cost for constructing a separate system can be reduced, and the process can be simplified.

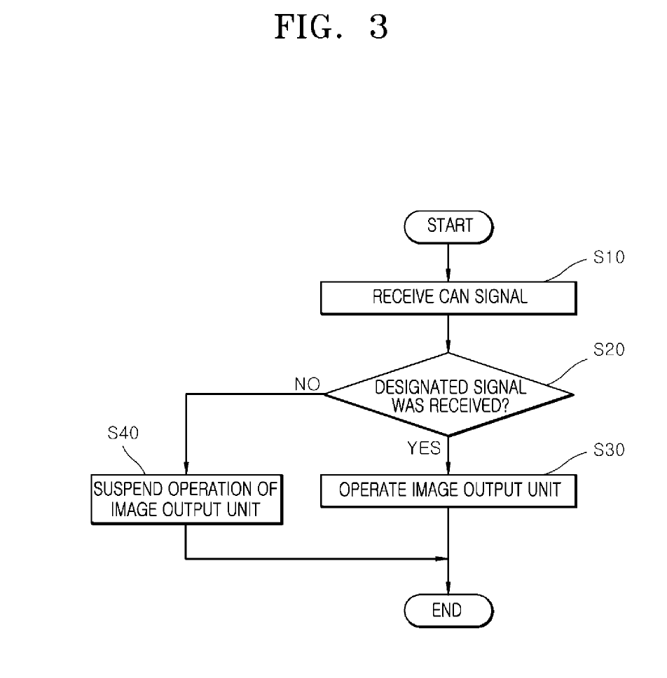

FIG. 3 is a flowchart illustrating a control method of a camera apparatus for a vehicle in accordance with an embodiment of the present invention.

As illustrated in FIG. 3, the control method of the camera apparatus for a vehicle in accordance with the embodiment of the present invention may start with step S10 in which the control unit 20 is connected to the in-vehicle communication network through the communication unit 30, and receives a signal according to an operation of the vehicle control unit 50.

The in-vehicle communication network may include a CAN, and the control unit 20 may receive a CAN signal through the communication unit 30.

After receiving the CAN signal at step S10, the control unit 20 may determine whether the designated signal was received.

At this time, the designated signal may include one or more of the gear position-R signal, the direction change signal, and the camera select signal.

When the first camera apparatus 100 is installed at the right of the vehicle and the second camera apparatus 200 is installed the rear of the vehicle as illustrated in FIG. 2, the direction change signal may be set as the designated signal for the first camera apparatus 100, and the gear position-R signal may be set as the designated signal for the second camera apparatus 200. Furthermore, one or more of the first and second camera apparatuses may set the designated signal according to the camera select signal.

Therefore, after receiving the CAN signal at step S10, the control unit 20 may determine whether the designated signal has been received.

For example, the first camera apparatus 100 may determine whether the direction change signal was received, and the second camera apparatus 200 may determine whether the gear position-R signal was received.

When it is determined at step S20 that the designated signal was received, the control unit 20 may operate the image output unit 40 to output an image taken by the imaging module 10 to the AVN system 60, at step S30.

On the other hand, when it is determined at step S20 that the designated signal was not received, the control unit 20 may suspend the operation of the image output unit 40 or maintain the suspended state such that no image is outputted, at step S40.

When the direction change signal is inputted to the first camera apparatus 100, the image may be outputted to the AVN system 60 to output the side image. When the gear position-R signal is inputted to the second camera apparatus 200, the image may be outputted to the AVN system 60 to output the rear image.

In accordance with the embodiment of the present invention, the control method of the camera apparatus for a vehicle can be connected to the in-vehicle communication network, receive a signal according to the operation of the vehicle control unit, and output an image taken by the camera module when the designated signal is inputted, thereby providing a blind spot image. Therefore, a cost for constructing a separate system can be reduced, and the process can be simplified.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A camera apparatus for a vehicle, comprising:
an imaging module configured to take an image of an area around the vehicle;
an image output unit configured to output the image taken by the imaging module;
a communication unit configured to provide an interface for connecting to an in-vehicle communication network; and
a control unit configured to operate the image output unit to output the image, when a designated signal according to an operation of a vehicle control unit is inputted from the communication unit.

2. The camera apparatus of claim 1, wherein the in-vehicle communication network comprises a Controller Area Network (CAN).

3. The camera apparatus of claim 1, wherein the designated signal comprises one or more of a gear position-reverse (R) signal, a direction change signal, and a camera select signal.

4. The camera apparatus of claim 1, wherein the control unit is configured to determine whether the designated signal was received, and suspends the operation of the image output unit or maintains a suspended state, when the designated signal was not received.

5. A control method of a camera apparatus for a vehicle, comprising:
connecting a control unit to an in-vehicle communication network through a communication unit, and receiving a signal according to an operation of a vehicle control unit;
comparing, by the control unit, the received signal, and determining whether the received signal is a designated signal; and
operating, by the control unit, an image output unit to output an image, when it is determined that the received signal is a designated signal.

6. The control method of claim 5, further comprising suspending, by the control unit, the operation of the image output unit or maintaining a suspended state, when it is determined that the designated signal was not received.

7. The control method of claim 5, wherein the in-vehicle communication network comprises a CAN.

8. The control method of claim 5, wherein the designated signal comprises one or more of a gear position-reverse (R) signal, a direction change signal, and a camera select signal.
